(19) United States
(12) Patent Application Publication
(10) Pub. No.: US 2017/0045613 A1
(43) Pub. Date: Feb. 16, 2017

(54) 360-degree electronic scan radar for collision avoidance in unmanned aerial vehicles

(71) Applicant: Zongbo WANG, Lawrence, KS (US)

(72) Inventor: Zongbo WANG, Lawrence, KS (US)

(21) Appl. No.: 14/824,056

(22) Filed: Aug. 11, 2015

(51) Int. Cl. G01S 13/93; G01S 13/87; G01S 7/02; G01S 7/35

(52) U.S. Cl. CPC G01S 13/9303; G01S 7/35; G01S 13/87; G01S 7/023

(57) ABSTRACT

The present invention provides a method for detecting an object, said method comprising: providing a plurality of nonrotating transmitting and receiving antennas at a location; transmitting an electromagnetic waveform from each of said plurality of nonrotating transmitting antennas for reflection from an object to be detected, each of said waveforms chosen so as to avoid interference with the other waveforms between transmitted signals and received signals; receiving reflected electromagnetic echo signals by the receiving antennas from the object to be detected and generating receiving signals corresponding to the echo signals; processing the receiving signals to determine relative location information about the object to be detected.

### TECHNICAL FIELD

The disclosure relates to the field of radar-based detection, and more particularly to a 360-degree electronic scan radar for collision avoidance in unmanned aerial vehicles.

### BACKGROUND

Radar is an object-detection system that uses radio waves to determine the range, altitude, direction, or speed of objects. It can be used to detect aircraft, ships, spacecraft, guided missiles, motor vehicles, weather formations, and terrain. The radar dish (or antenna) transmits pulses of radio waves or microwaves that bounce off any object in their path. The object returns a tiny part of the wave's energy to a dish or antenna that is usually located at the same site as the transmitter.

The modern uses of radar are highly diverse, including air and terrestrial traffic control, radar astronomy, air-defense systems, antimissile systems; marine radars to locate landmarks and other ships; aircraft anticollision systems; ocean surveillance systems, outer space surveillance and rendezvous systems; meteorological precipitation monitoring; altimetry and flight control systems; guided missile target locating systems; and ground-penetrating radar for geological observations. High tech radar systems are associated with digital signal processing and are capable of extracting useful information from very high noise levels.

Other systems similar to radar make use of other parts of the electromagnetic spectrum. One example is “lidar”, which uses ultraviolet, visible, or near infrared light from lasers rather than radio waves.

The information provided by radar includes the bearing and range (and therefore position) of the object from the radar scanner. It is thus used in many different fields where the need for such positioning is crucial. In aviation, aircraft are equipped with radar devices that warn of aircraft or other obstacles in or approaching their path, display weather information, and give accurate altitude readings.

Marine radars are used to measure the bearing and distance of ships to prevent collision with other ships, to navigate, and to fix their position at sea when within range of shore or other fixed references such as islands, buoys, and lightships. In port or in harbour, vessel traffic service radar systems are used to monitor and regulate ship movements in busy waters.

Meteorologists use radar to monitor precipitation and wind. It has become the primary tool for short-term weather forecasting and watching for severe weather such as thunderstorms, tornadoes, winter storms, precipitation types, etc. Geologists use specialised ground-penetrating radars to map the composition of Earth's crust. Police forces use radar guns to monitor vehicle speeds on the roads.

A radar system has a transmitter that emits radio waves called radar signals in predetermined directions. When these come into contact with an object they are usually reflected or scattered in many directions. Radar signals are reflected especially well by materials of considerable electrical conductivity—especially by most metals, by seawater and by wet ground. Some of these make the use of radar altimeters possible. The radar signals that are reflected back towards the transmitter are the desirable ones that make radar work. If the object is moving either toward or away from the transmitter, there is a slight equivalent change in the frequency of the radio waves, caused by the Doppler effect.

Radar receivers are usually, but not always, in the same location as the transmitter. Although the reflected radar signals captured by the receiving antenna are usually very weak, they can be strengthened by electronic amplifiers. More sophisticated methods of signal processing are also used in order to recover useful radar signals.

The weak absorption of radio waves by the medium through which it passes is what enables radar sets to detect objects at relatively long ranges—ranges at which other electromagnetic wavelengths, such as visible light, infrared light, and ultraviolet light, are too strongly attenuated. Such weather phenomena as fog, clouds, rain, falling snow, and sleet that block visible light are usually transparent to radio waves. Certain radio frequencies that are absorbed or scattered by water vapor, raindrops, or atmospheric gases (especially oxygen) are avoided in designing radars, except when their detection is intended.

Radar relies on its own transmissions rather than light from the Sun or the Moon, or from electromagnetic waves emitted by the objects themselves, such as infrared wavelengths (heat). This process of directing artificial radio waves towards objects is called illumination, although radio waves are invisible to the human eye or optical cameras.

If electromagnetic waves traveling through one material meet another, having a very different dielectric constant or diamagnetic constant from the first, the waves will reflect or scatter from the boundary between the materials. This means that a solid object in air or in a vacuum, or a significant change in atomic density between the object and what is surrounding it, will usually scatter radar (radio) waves from its surface. This is particularly true for electrically conductive materials such as metal and carbon fiber, making radar well-suited to the detection of aircraft and ships. Radar absorbing material, containing resistive and sometimes magnetic substances, is used on military vehicles to reduce radar reflection. This is the radio equivalent of painting something a dark color so that it cannot be seen by the eye at night.

Radar waves scatter in a variety of ways depending on the size (wavelength) of the radio wave and the shape of the target. If the wavelength is much shorter than the target's size, the wave will bounce off in a way similar to the way light is reflected by a mirror. If the wavelength is much longer than the size of the target, the target may not be visible because of poor reflection. Low-frequency radar technology is dependent on resonances for detection, but not identification, of targets. This is described by Rayleigh scattering, an effect that creates Earth's blue sky and red sunsets. When the two length scales are comparable, there may be resonances. Early radars used very long wavelengths that were larger than the targets and thus received a vague signal, where as some modern systems use shorter wavelengths (a few centimeters or less) that can image objects as small as a loaf of bread.

Short radio waves reflect from curves and corners in a way similar to glint from a rounded piece of glass. The most reflective targets for short wavelengths have 90° angles between the reflective surfaces. A corner reflector consists of three flat surfaces meeting like the inside corner of a box. The structure will reflect waves entering its opening directly back to the source. They are commonly used as radar reflectors to make otherwise difficult-to-detect objects easier to detect. Corner reflectors on boats, for example, make them more detectable to avoid collision or during a rescue. For similar reasons, objects intended to avoid detection will not have inside corners or surfaces and edges perpendicular to likely detection directions, which leads to “odd” looking stealth aircraft. These precautions do not completely eliminate reflection because of diffraction, especially at longer wavelengths. Half wavelength long wires or strips of conducting material, such as chaff, are very reflective but do not direct the scattered energy back toward the source. The extent to which an object reflects or scatters radio waves is called its radar cross section.

The power Pᵣ returning to the receiving antenna is given by the equation:

Pᵣ=(PₜGₜAᵣσF⁴)/((4π)²Rₜ²Rᵣ²)

where

Pₜ=transmitter power

Gₜ=gain of the transmitting antenna

Aᵣ=effective aperture (area) of the receiving antenna (most of the time noted as Gᵣ)

σ=radar cross section, or scattering coefficient, of the target

F=pattern propagation factor

Rₜ=distance from the transmitter to the target

Rᵣ=distance from the target to the receiver.

In the common case where the transmitter and the receiver are at the same location, Rₜ=Rᵣ and the term Rₜ² Rᵣ² can be replaced by R⁴, where R is the range. This yields:

Pᵣ=(PₜGₜAᵣσF⁴)/((4π)²R⁴).

This shows that the received power declines as the fourth power of the range, which means that the received power from distant targets is relatively very small.

Additional filtering and pulse integration modifies the radar equation slightly for pulse-Doppler radar performance, which can be used to increase detection range and reduce transmit power.

The equation above with F=1 is a simplification for transmission in a vacuum without interference. The propagation factor accounts for the effects of multipath and shadowing and depends on the details of the environment. In a real-world situation, pathloss effects should also be considered.

Frequency shift is caused by motion that changes the number of wavelengths between the reflector and the radar. That can degrade or enhance radar performance depending upon how that affects the detection process. As an example, Moving Target Indication can interact with Doppler to produce signal cancellation at certain radial velocities, which degrades performance.

Sea-based radar systems, semi-active radar homing, active radar homing, weather radar, military aircraft, and radar astronomy rely on the Doppler effect to enhance performance. This produces information about target velocity during the detection process. This also allows small objects to be detected in an environment containing much larger nearby slow moving objects.

Doppler shift depends upon whether the radar configuration is active or passive. Active radar transmits a signal that is reflected back to the receiver. Passive radar depends upon the object sending a signal to the receiver.

The Doppler frequency shift for active radar is as follows, where F_{D} is Doppler frequency, F_{T} is transmit frequency, V_{R} is radial velocity, and C is the speed of light:

F_{D}=2×F_{T}×(V_{R}/C)

Passive radar is applicable to electronic countermeasures and radio astronomy as follows:

F_{D}=F_{T}×(V_{R}/C)

Only the radial component of the speed is relevant. When the reflector is moving at right angle to the radar beam, it has no relative velocity. Vehicles and weather moving parallel to the radar beam produce the maximum Doppler frequency shift.

Doppler measurement is reliable only if the sampling rate exceeds the Nyquist frequency for the frequency shift produced by radial motion. As an example, Doppler weather radar with a pulse rate of 2 kHz and transmit frequency of 1 GHz can reliably measure weather up to 150 m/s (340 mph), but cannot reliably determine radial velocity of aircraft moving 1,000 m/s (2,200 mph).

In all electromagnetic radiation, the electric field is perpendicular to the direction of propagation, and this direction of the electric field is the polarization of the wave. In the transmitted radar signal the polarization can be controlled for different effects. Radars use horizontal, vertical, linear and circular polarization to detect different types of reflections. For example, circular polarization is used to minimize the interference caused by rain. Linear polarization returns usually indicate metal surfaces. Random polarization returns usually indicate a fractal surface, such as rocks or soil, and are used by navigation radars.

The radar beam would follow a linear path in vacuum, but it really follows a somewhat curved path in the atmosphere because of the variation of the refractive index of air, that is called the radar horizon. Even when the beam is emitted parallel to the ground, it will rise above it as the Earth curvature sinks below the horizon. Furthermore, the signal is attenuated by the medium it crosses, and the beam disperses.

The maximum range of a conventional radar can be limited by a number of factors:

Line of sight, which depends on height above ground. This means with out a direct line of sight the path of the beam is blocked.

The maximum non-ambiguous range, which is determined by the pulse repetition frequency. The maximum non-ambiguous range is the distance the pulse could travel and return before the next pulse is emitted.

Radar sensitivity and power of the return signal as computed in the radar equation. This includes factors such as environmental conditions and the size (or radar cross section) of the target.

Signal noise is an internal source of random variations in the signal, which is generated by all electronic components.

Reflected signals decline rapidly as distance increases, so noise introduces a radar range limitation. The noise floor and signal to noise ratio are two different measure of performance that impact range performance. Reflectors that are too far away produce too little signal to exceed the noise floor and cannot be detected. Detection requires a signal that exceeds the noise floor by at least the signal to noise ratio.

Noise typically appears as random variations superimposed on the desired echo signal received in the radar receiver. The lower the power of the desired signal, the more difficult it is to discern it from the noise. Noise figure is a measure of the noise produced by a receiver compared to an ideal receiver, and this needs to be minimized.

Shot noise is produced by electrons in transit across a discontinuity, which occurs in all detectors. Shot noise is the dominant source in most receivers. There will also be flicker noise caused by electron transit through amplification devices, which is reduced using heterodyne amplification. Another reason for heterodyne processing is that for fixed fractional bandwidth, the instantaneous bandwidth increases linearly in frequency. This allows improved range resolution. The one notable exception to heterodyne (downconversion) radar systems is ultra-wideband radar.

Noise is also generated by external sources, most importantly the natural thermal radiation of the background surrounding the target of interest. In modern radar systems, the internal noise is typically about equal to or lower than the external noise. An exception is if the radar is aimed upwards at clear sky, where the scene is so “cold” that it generates very little thermal noise.

Radar systems must overcome unwanted signals in order to focus only on the actual targets of interest. These unwanted signals may originate from internal and external sources, both passive and active. The ability of the radar system to overcome these unwanted signals defines its signal-to-noise ratio (SNR). SNR is defined as the ratio of a signal power to the noise power within the desired signal; it compares the level of a desired target signal to the level of background noise (atmospheric noise and noise generated within the receiver). The higher a system's SNR, the better it is in isolating actual targets from the surrounding noise signals.

Clutter refers to radio frequency (RF) echoes returned from targets which are uninteresting to the radar operators. Such targets include natural objects such as ground, sea, precipitation (such as rain, snow or hail), sand storms, animals (especially birds), atmospheric turbulence, and other atmospheric effects, such as ionosphere reflections, meteor trails, and Hail spike. Clutter may also be returned from man-made objects such as buildings and, intentionally, by radar countermeasures such as chaff.

Some clutter may also be caused by a long radar waveguide between the radar transceiver and the antenna. In a typical plan position indicator (PPI) radar with a rotating antenna, this will usually be seen as a “sun” or “sunburst” in the centre of the display as the receiver responds to echoes from dust particles and misguided RF in the waveguide. Adjusting the timing between when the transmitter sends a pulse and when the receiver stage is enabled will generally reduce the sunburst without affecting the accuracy of the range, since most sunburst is caused by a diffused transmit pulse reflected before it leaves the antenna. Clutter is considered a passive interference source, since it only appears in response to radar signals sent by the radar.

Clutter is detected and neutralized in several ways. Clutter tends to appear static between radar scans; on subsequent scan echoes, desirable targets will appear to move, and all stationary echoes can be eliminated. Sea clutter can be reduced by using horizontal polarization, while rain is reduced with circular polarization (note that meteorological radars wish for the opposite effect, and therefore use linear polarization to detect precipitation). Other methods attempt to increase the signal-to-clutter ratio.

The most effective clutter reduction technique is pulse-Doppler radar. Doppler separates clutter from aircraft and spacecraft using a frequency spectrum, so individual signals can be separated from multiple reflectors located in the same volume using velocity differences. This requires a coherent transmitter. Another technique uses a moving target indicator that subtracts the receive signal from two successive pulses using phase to reduce signals from slow moving objects. This can be adapted for systems that lack a coherent transmitter, such as time-domain pulse-amplitude radar.

One way to obtain a distance measurement is based on the time-of-flight: transmit a short pulse of radio signal (electromagnetic radiation) and measure the time it takes for the reflection to return. The distance is one-half the product of the round trip time (because the signal has to travel to the target and then back to the receiver) and the speed of the signal. Since radio waves travel at the speed of light, accurate distance measurement requires high-performance electronics. In most cases, the receiver does not detect the return while the signal is being transmitted. Through the use of a duplexer, the radar switches between transmitting and receiving at a predetermined rate. A similar effect imposes a maximum range as well. In order to maximize range, longer times between pulses should be used, referred to as a pulse repetition time, or its reciprocal, pulse repetition frequency.

These two effects tend to be at odds with each other, and it is not easy to combine both good short range and good long range in a single radar. This is because the short pulses needed for a good minimum range broadcast have less total energy, making the returns much smaller and the target harder to detect. This could be offset by using more pulses, but this would shorten the maximum range. So each radar uses a particular type of signal. Long-range radars tend to use long pulses with long delays between them, and short range radars use smaller pulses with less time between them. As electronics have improved many radars now can change their pulse repetition frequency, thereby changing their range. The newest radars fire two pulses during one cell, one for short range (10 km/6 miles) and a separate signal for longer ranges (100 km/60 miles).

The distance resolution and the characteristics of the received signal as compared to noise depends on the shape of the pulse. The pulse is often modulated to achieve better performance using a technique known as pulse compression.

Distance may also be measured as a function of time. The radar mile is the amount of time it takes for a radar pulse to travel one nautical mile, reflect off a target, and return to the radar antenna. Since a nautical mile is defined as 1,852 meters, then dividing this distance by the speed of light (299,792,458 meters per second), and then multiplying the result by 2 yields a result of 12.36 microseconds in duration.

Another form of distance measuring radar is based on frequency modulation. Frequency comparison between two signals is considerably more accurate, even with older electronics, than timing the signal. By measuring the frequency of the returned signal and comparing that with the original, the difference can be easily measured.

This technique can be used in continuous wave radar and is often found in aircraft radar altimeters. In these systems a “carrier” radar signal is frequency modulated in a predictable way, typically varying up and down with a sine wave or sawtooth pattern at audio frequencies. The signal is then sent out from one antenna and received on another, typically located on the bottom of the aircraft, and the signal can be continuously compared using a simple beat frequency modulator that produces an audio frequency tone from the returned signal and a portion of the transmitted signal.

Since the signal frequency is changing, by the time the signal returns to the aircraft the transmit frequency has changed. The amount of frequency shift is used to measure distance.

The modulation index riding on the receive signal is proportional to the time delay between the radar and the reflector. The amount of that frequency shift becomes greater with greater time delay. The measure of the amount of frequency shift is directly proportional to the distance traveled. That distance can be displayed on an instrument, and it may also be available via the transponder. This signal processing is similar to that used in speed detecting Doppler radar.

Speed is the change in distance to an object with respect to time. Thus the existing system for measuring distance, combined with a memory capacity to see where the target last was, is enough to measure speed. If the transmitter's output is coherent (phase synchronized), there is another effect that can be used to make almost instant speed measurements (no memory is required), known as the Doppler effect. Most modern radar systems use this principle into Doppler radar and pulse-Doppler radar systems (weather radar, military radar, etc. . . . ). The Doppler effect is only able to determine the relative speed of the target along the line of sight from the radar to the target. Any component of target velocity perpendicular to the line of sight cannot be determined by using the Doppler effect alone, but it can be determined by tracking the target's azimuth over time.

It is possible to make a Doppler radar without any pulsing, known as a continuous-wave radar (CW radar), by sending out a very pure signal of a known frequency. CW radar is ideal for determining the radial component of a target's velocity. CW radar is typically used by traffic enforcement to measure vehicle speed quickly and accurately where range is not important.

When using a pulsed radar, the variation between the phase of successive returns gives the distance the target has moved between pulses, and thus its speed can be calculated. Other mathematical developments in radar signal processing include time-frequency analysis (Weyl Heisenberg or wavelet), as well as the chirplet transform which makes use of the change of frequency of returns from moving targets (“chirp”).

Pulse-Doppler signal processing includes frequency filtering in the detection process. The space between each transmit pulse is divided into range cells or range gates. Each cell is filtered independently much like the process used by a spectrum analyzer to produce the display showing different frequencies. Each different distance produces a different spectrum. These spectra are used to perform the detection process. This is required to achieve acceptable performance in hostile environments involving weather, terrain, and electronic countermeasures.

The primary purpose is to measure both the amplitude and frequency of the aggregate reflected signal from multiple distances. This is used with weather radar to measure radial wind velocity and precipitation rate in each different volume of air.

Signal processing is employed in radar systems to reduce the radar interference effects. Signal processing techniques include moving target indication, Pulse-Doppler signal processing, moving target detection processors, correlation with secondary surveillance radar targets, space-time adaptive processing, and track-before-detect. Constant false alarm rate and digital terrain model processing are also used in clutter environments.

A radar's components include: A transmitter that generates the radio signal with an oscillator such as a klystron or a magnetron and controls its duration by a modulator; A waveguide that links the transmitter and the antenna; A duplexer that serves as a switch between the antenna and the transmitter or the receiver for the signal when the antenna is used in both situations; A receiver. Knowing the shape of the desired received signal (a pulse), an optimal receiver can be designed using a matched filter; A display processor to produce signals for human readable output devices; An electronic section that controls all those devices and the antenna to perform the radar scan ordered by software; A link to end user devices and displays.

Radio signals broadcast from a single antenna will spread out in all directions, and likewise a single antenna will receive signals equally from all directions. This leaves the radar with the problem of deciding where the target object is located.

Early systems tended to use omnidirectional broadcast antennas, with directional receiver antennas which were pointed in various directions. For instance, the first system to be deployed, Chain Home, used two straight antennas at right angles for reception, each on a different display. The maximum return would be detected with an antenna at right angles to the target, and a minimum with the antenna pointed directly at it (end on). The operator could determine the direction to a target by rotating the antenna so one display showed a maximum while the other showed a minimum. One serious limitation with this type of solution is that the broadcast is sent out in all directions, so the amount of energy in the direction being examined is a small part of that transmitted. To get a reasonable amount of power on the “target”, the transmitting aerial should also be directional.

More modern systems use a steerable parabolic “dish” to create a tight broadcast beam, typically using the same dish as the receiver. Such systems often combine two radar frequencies in the same antenna in order to allow automatic steering, or radar lock.

Parabolic reflectors can be either symmetric parabolas or spoiled parabolas: Symmetric parabolic antennas produce a narrow “pencil” beam in both the X and Y dimensions and consequently have a higher gain. Spoiled parabolic antennas produce a narrow beam in one dimension and a relatively wide beam in the other. This feature is useful if target detection over a wide range of angles is more important than target location in three dimensions. Most 2D surveillance radars use a spoiled parabolic antenna with a narrow azimuthal beamwidth and wide vertical beamwidth. This beam configuration allows the radar operator to detect an aircraft at a specific azimuth but at an indeterminate height. Conversely, so-called “nodder” height finding radars use a dish with a narrow vertical beamwidth and wide azimuthal beamwidth to detect an aircraft at a specific height but with low azimuthal precision.

Phase array antennas are composed of evenly spaced similar antenna elements, such as aerials or rows of slotted waveguide. Each antenna element or group of antenna elements incorporates a discrete phase shift that produces a phase gradient across the array.

Phased array radars have been in use since the earliest years of radar in World War II (Mammut radar), but electronic device limitations led to poor performance. Phased array radars were originally used for missile defense (see for example Safeguard Program). They are the heart of the ship-borne Aegis Combat System and the Patriot Missile System. The massive redundancy associated with having a large number of array elements increases reliability at the expense of gradual performance degradation that occurs as individual phase elements fail.

Phased array antenna can be built to conform to specific shapes, like missiles, infantry support vehicles, ships, and aircraft.

As the price of electronics has fallen, phased array radars have become more common. Almost all modern military radar systems are based on phased arrays, where the small additional cost is offset by the improved reliability of a system with no moving parts. Traditional moving-antenna designs are still widely used in roles where cost is a significant factor such as air traffic surveillance, weather radars and similar systems.

Phased-array interferometry or aperture synthesis techniques, using an array of separate dishes that are phased into a single effective aperture, are not typical for radar applications, although they are widely used in radio astronomy. Because of the thinned array curse, such multiple aperture arrays, when used in transmitters, result in narrow beams at the expense of reducing the total power transmitted to the target. In principle, such techniques could increase spatial resolution, but the lower power means that this is generally not effective.

Aperture synthesis by post-processing motion data from a single moving source, on the other hand, is widely used in space and airborne radar systems.

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problems with which this specification is concerned.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

### SUMMARY

The present invention may address one or more of the problems and deficiencies of the prior art discussed above. However, it is contemplated that the invention may prove useful in addressing other problems and deficiencies in a number of technical areas. Therefore the claimed invention should not necessarily be construed as limited to addressing any of the particular problems or deficiencies discussed herein.

Certain embodiments of the present invention are directed to radar systems that provide one or more benefits and advantages not previously offered by the prior art, including, but not limited to, radar systems that are reliable, accurate, effective in scanning a 360 degree azimuth, cost competitive, and of a light weight.

The present invention provides a method for detecting an object, said method comprising: providing a plurality of nonrotating transmitting and receiving antennas at a location; transmitting an electromagnetic waveform from each of said plurality of nonrotating transmitting antennas for reflection from an object to be detected, each of said waveforms chosen so as to avoid interference with the other waveforms between transmitted signals and received signals; receiving reflected electromagnetic echo signals by the receiving antennas from the object to be detected and generating receiving signals corresponding to the echo signals; processing the receiving signals to determine relative location information about the object to be detected.

The present invention provides an apparatus for detecting an object, said apparatus comprising: a plurality of nonrotating transmitting and receiving antennas at a location; said plurality of nonrotating transmitting antennas each adapted to transmit an electromagnetic waveform for reflection from an object to be detected, each of said waveforms chosen so as to avoid interference with the waveforms; said plurality of nonrotating receiving antennas adapted to receiving a reflected electromagnetic echo signal from an object to be detected and from other transmitting antennas; and a digital signal processor adapted to processing the reflected echo signals to determine relative location information about the object to be detected.

Unmanned aerial vehicles and drones need to sense the surroundings in order to avoid collision. The existing radar-based collision avoidance sensing solutions are based on mechanical scan by installing directional radar antenna on a rotating motor, this brings potential chances of mechanical failure during UAV flight.

A 360-degree radar structure for collision avoidance in unmanned aerial vehicles (UAV) is provided. The proposed radar places a pair of transmit antenna and receive antenna on each side of a polygon plane, for example, a pentagon, hexagon or octagon plane. The whole 360 degrees can then be divided into several azimuth regions. The polygon plane selection can determine the resolution in azimuth. It can be any polygon with equal length on each edge, according to the number of edges on the polygon plane. Radar transmits a specific waveform modulated at specified central frequency through each transmit antenna, the transmitted waveforms through different antennas would not interfere with each other. The proposed radar can be installed on UAVs and detects any obstacle around the UAV during flight. The detected obstacle azimuth information and distance information can be sent to UAV flight control unit to adjust the UAV flight trajectory to avoid collision.

The top-view profile structure of the proposed radar is illustrated in FIG. 1: 6 pairs of transmit antenna and receive antenna are placed on each side of a hexagon structure. The whole 360-degree around UAV is then divided into 6 scan-regions, e.g. scan region-1 to scan region-6. Each scan region uses specific waveforms, e.g. waveform 1 for scan region 1, waveform 2 for scan region 2, etc. Each waveform must be non-identical with every other waveform, otherwise the waveform would interfere with each other. This is so that the obstacle in one scan region (an obstacle in scan region 2, in FIG. 1) will not generate any interference to other scan regions.

The proposed radar system uses multiple antennas to divide the 360-degree into multi-scan regions. It uses orthogonal waveforms to avoid the interference and ambiguity between scan regions. It provides an adaptive scan (signal processing) algorithms according to the UAV flight status, such as directional heading, velocity, acceleration, etc.

### BRIEF DESCRIPTION OF THE DRAWINGS

The drawings illustrated here are to provide further understanding of the disclosure and constitute one part of the application, and the exemplary embodiments of the disclosure and the explanations thereof are intended to explain the disclosure, instead of improperly limiting the disclosure. In the drawings:

FIG. 1 is a schmatic plan view of a hexagonal implementation of the invention, dividing the 360-degree periphery arpond the system into 6 scan regions;

FIG. 2 is a schematic view of a system composition, in a hexagon shape;

FIG. 3 is a block diagram of the radar transmitting chain and receiving chain;

FIG. 4 is a graphical representation of a signal transmission with an offset in start frequency and stop frequency to create isolation between channels;

FIG. 5 is a block diagram of Received signal processing;

FIG. 6 is a flow diagram of an adaptive scan algorithm; and

FIG. 7 is a block diagram of RF modulation and demodulation.

### DETAILED DESCRIPTION OF THE EMBODIMENTS

The disclosure will be described below with reference to the annexed drawings and embodiments in detail. It should be noted that, in case of no conflict, the recited embodiments and the features therein can be combined with one another.

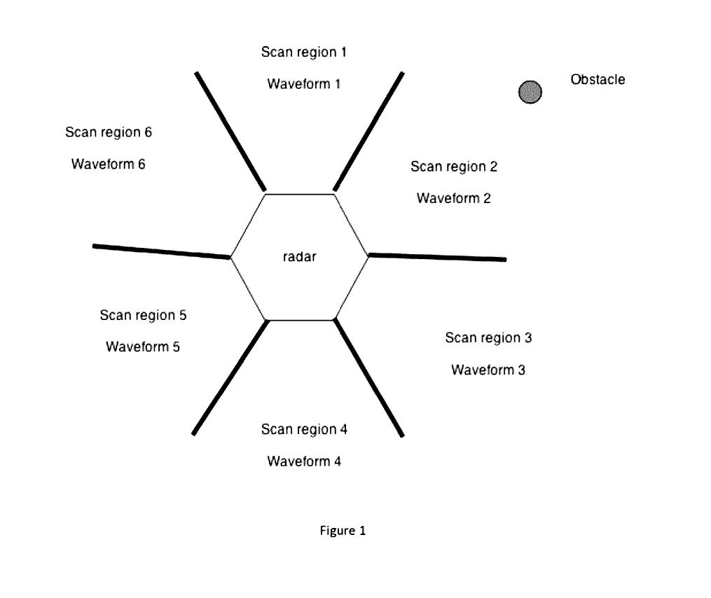

In a first embodiment, the top-view profile structure of the proposed radar is illustrated in FIG. 1, a pair of transmit antennas and receive antennas is placed on each side of a hexagon structure. The whole 360-degree periphery around the UAV or other vehicle on which the system is placed is then divided into 6 scan-regions, e.g. scan region-1 to scan region-6 in FIG. 1. Each scan region uses specific waveforms, e.g. waveform 1 for scan region 1, waveform 2 for scan region 2, etc. Each waveform must be non-identical with every other waveform, otherwise the waveforms would interfere with each other. This is so that the signals reflected from an obstacle in one scan region (an obstacle in scan region 2, in FIG. 1) will not generate any interference into other scan regions.

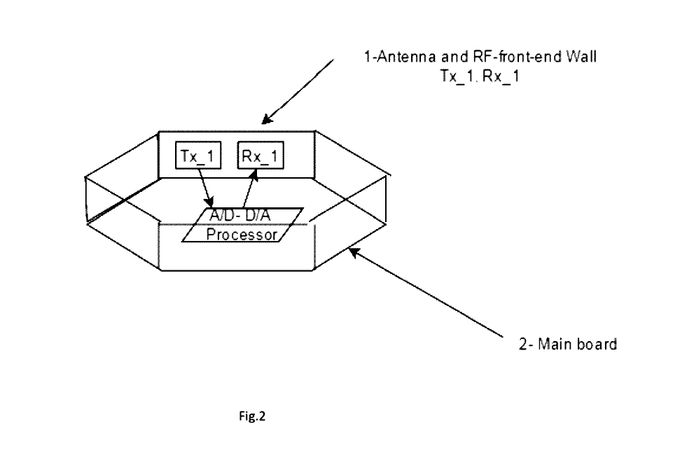

As seen in FIG. 2, an antennas and RF front-end wall” is installed in perpendicular to the hexagonal main plane on each side of the hexagonal array. Each antenna and RF front-end wall is composed by one transmit antenna, one receive antenna and a radio frequency (RF) circuit to transmit high frequency signals through the transmit antennas and to receive the reflected echo signal from the receive antenna. The antennas may be patch antennas or the-so called “microstrip antennas. As known in the art. Such antennas are flat in shape and can be printed on a printed circuit board. Thus, the antennas can be printed on the side wall of the wall structure using a standard PCB process.

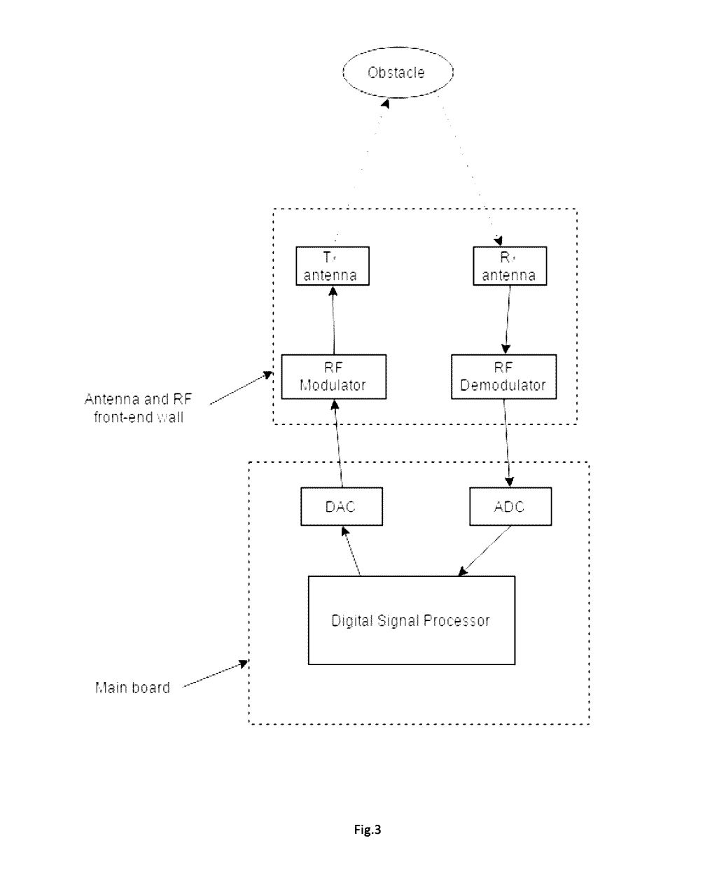

With reference to FIG. 3, the main board is the mother board for the system, hosting a multi-channel analog to digital converter (ADC,) to convert the received echo signal from the RF front-end to a digital signal for further signal processing); a digital to analog converter (DAC), to generate an analog signal to stimulate the RF front-end for signal transmission; and a digital signal processor to conduct signal transmitting and receiving control and run signal processing algorithms to retrieve target Information. Such circuitry is known in the art.

The radar system runs on linear frequency modulated continuous-wave (LFMCW) principles. Taking one channel as an example, the radar transmitting chain and receiving chain is also illustrated in FIG. 3. The left arm is the signal transmitting chain and the right arm is the signal receiving chain, in which the circuits on the main board are coupled to the antenna and RF front-end wall circuits. In the signal transmitting chain, the transmit signal is first generated in the digital signal processor in digital form, then converted to an analog signal in the DAC. The analog signal is then modulated with a particular certain carrier frequency, for example, 24 GHz, 60 GHz, or 120 GHz, with an extended bandwidth, for example, a 500 MHz-1 GHz bandwidth is typical, in the RF modulator and further transmitted through the Tx antenna.

An example of one RF modulation approach that can be employed is to use the analog voltage to stimulate a voltage-controlled oscillator (VCO) to generate the desired radio frequency signal with certain start and stop frequency. Other modulation methods, as known in the art, may also be employed.

In the signal receiving chain, the reflected signal from a sensed obstacle received by the Rx antenna is first conditioned and filtered and demodulated by the RF demodulator. The baseband signal is then converted to digital form by ADC. The digitized signal is in the digital signal processor to retrieve the target (obstacle) information.

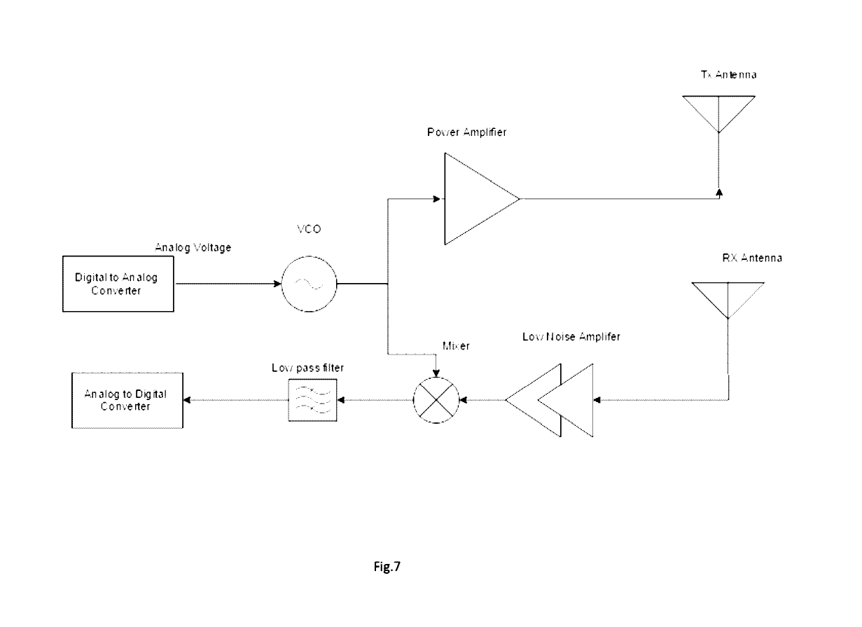

An example implementation of echo signal filtering and conditioning is illustrated in FIG. 7, and may include a low noise amplifier (LNA) to increase the signal to noise ratio (SNR) of the received echo signal and a low pass filter (LPF) to filter the interference out of the frequency of interests. Such techniques are known in the art.

An exemplary implementation of RF modulation, signal filtering and conditioning and RF demodulation functions is as follows as further shown in FIG. 7:

The RF transmit section:

1—A digital to analog converter generates an analog voltage with the range of 0-3.3 volt.

2—The analog voltage signal is sent to a voltage-controlled oscillator (VCO) to generate a RF frequency with the start frequency of 23.5 GHz to 25.5 GHz.

3—23.5 GHz to 25.5 GHz RF signal is amplified through a power amplifier and eventually transmitted through the Tx antenna.

The RF receive section:

1—A echo signal reflected from an obstacle is received through Rx Antenna.

2—The received signal is first amplified by a low noise amplifier.

3—The amplified signal is mixed with the transmitted signal to be demodulated into an intermediate frequency (IF). The IF signal then carries target distance information and is modulated with a Doppler frequency shift.

4—The IF signal is filtered by a low pass filter and eventually digitized by an analog-to-digital converter.

The detailed operating flow and key aspects of each step is described below:

Step 1—Signal Transmission

The radar system simultaneously transmits signals through all the transmitting antennas. To avoid the interference between each set of transmitting signals and received echo signals, each antenna channel is specially coded with a different start frequency and stop frequency, controlled by the processor on the main board.

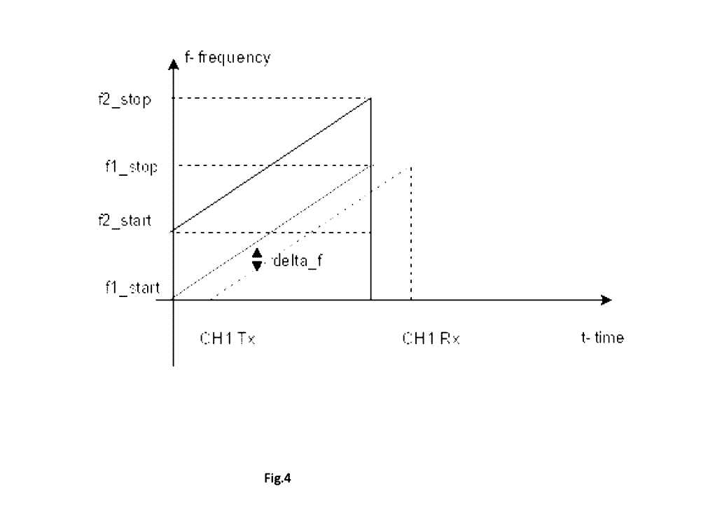

FIG. 4 illustrates how the offset in start stop frequencies create the isolation between channels.

The channel 1 transmit signal is modulated in frequency from f1_start to f1_stop; the channel 2 transmit signal is modulated from f2_start to f2_stop, etc. Any obstacle/target reflection from Channel 1 will create a frequency offset of delta_f. If the maximum target frequency offset meet the following condition:
MAX (delta_f)<(f1_stop−f1_start) (1) interference created from simultaneous signal transmitting can be eliminated by the low pass filtering. For example, for an f1_start=23.5 GHz and an f1_stop=25.5 GHz, within the time interval of T=1 ms, an obstacle at the distance of R will create a frequency offset equals to:

delta_f=[(f1_stop−f1_start)/T]*[(2*R)/c] (2)

where c is the propagation speed of the microwave signals and is approximately equals to 3e8 m/s.

If a chosen maximum obstacle detection range is 100 m, the maximum frequency offset created by the obstacle equals 1.33 MHz. So if the f2_start frequency is configured as any frequency greater than f1_start+1.33 MHz, and f2_stop is configured as any frequency more than f1_stop+1.33 MHz, the channel 2 signal will not generate any interference to the channel 1 signal. Orthogonality between different channels is established.

Step 2—Received Signal Processing

The received signal carries the distance and azimuth information from the obstacle. The distance information from the target can be calculated through a 1D-Fourier transform by estimating the frequency differences between the transmitted signal and the received signal. The azimuth information can be retrieved by comparing the 1D Fourier transform output between different channels.

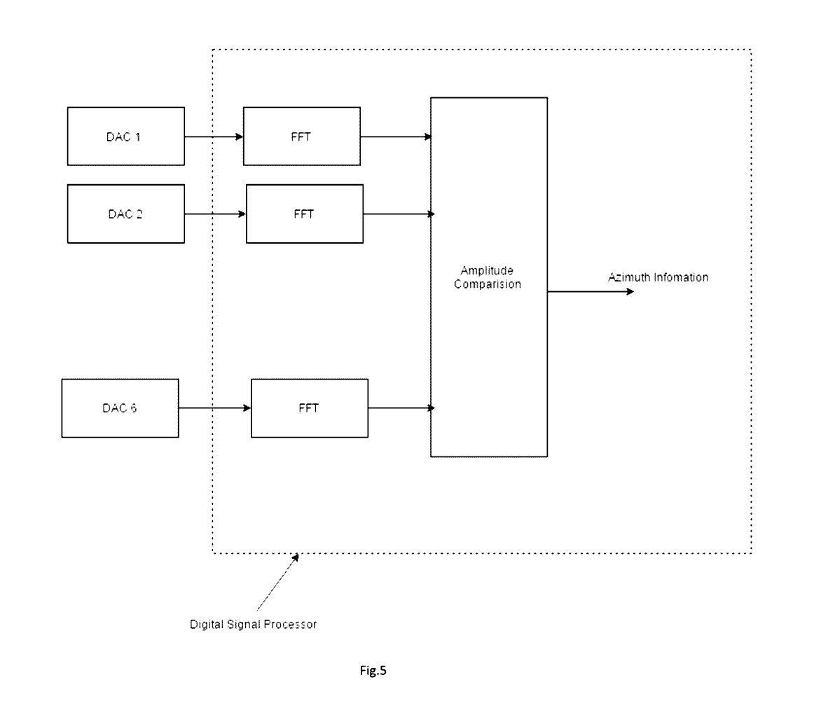

The resolution in azimuth depends on how many edges the main board has, e.g. a hexagon shaped main board divides the whole 360 degree surrounding into 6 60-degree scan zones. The target azimuth information can be determined by feeding all the 6 scan zone FFT outputs to an amplitude comparator, following the processing structure illustrated in FIG. 5, which presents a digital signal processor having an input channel for each channel, performing a FFT on each signal, and comparing the FFT outputs in amplitude comparison circuitry to yield obstacle azimuth information.

Step 3—Obstacle Identification and Avoidance

The final task of system operation is to further identify the obstacle through checking the Doppler signature created by the relative velocity between the obstacle and the UAV on which the system in installed. The UAV can then further avoid a collision with the obstacle by adjusting its flight trajectory.

An further exemplary system is described below. As recited above, the wall structure need not be hexagonal; use of an octagonal system is thus explained, as follows:

A hexagon structure with 3.5 cm length for each edge is designed to host 8 transmitting channels. The 360 degree surrounding is thus divided into 8 regions, each covering 45 degrees.

The bandwidth of each transmitting channel may be setup as 2 GHz within the time interval of 1 ms. Considering a maximum obstacle detection rang of 100 m, the maximum frequency offset created from a target is 1.33 MHz as calculated from equation (2). To create a certain safety margin for channel isolation, a 1.5 MHz increment is included for setting the start and stop frequency for each channel. The following table shows the start frequency and stop frequency for each transmitting channel.

| | Start | Stop |
|---|---|---|
| Channel | frequency | frequency |
| Number | (GHz) | (GHz) |
| 1 | 23.5 | 25.5 |
| 2 | 23.5015 | 25.5015 |
| 3 | 23.503 | 25.503 |
| 4 | 23.5045 | 25.5045 |
| 5 | 23.506 | 25.506 |
| 6 | 23.5075 | 25.5075 |
| 7 | 23.509 | 25.509 |
| 8 | 23.5105 | 25.5105 |

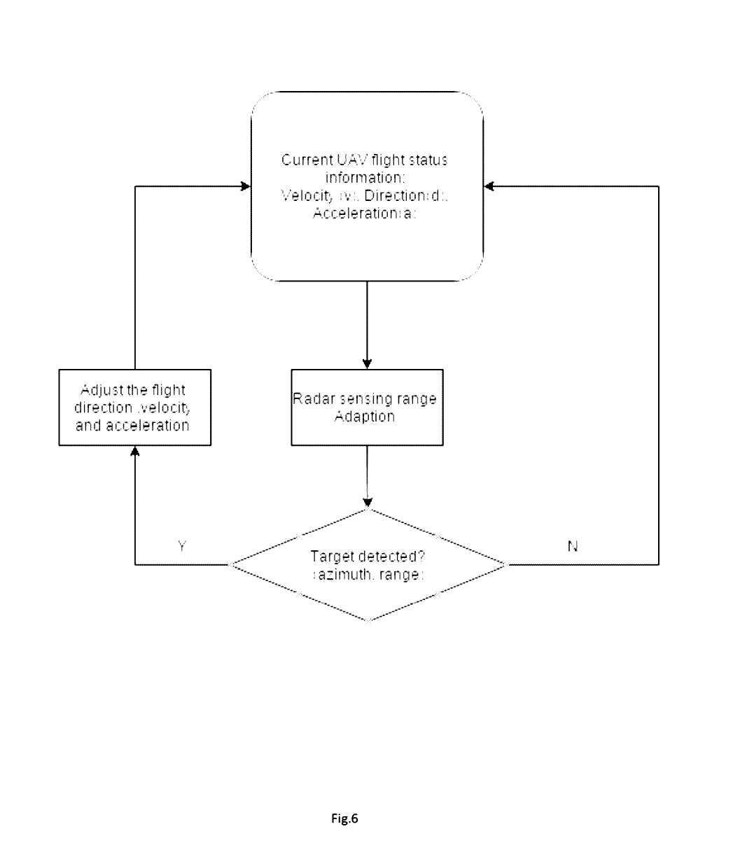

FIG. 6 shows an adaptive scan algorithm that may be used in connection with the present invention. The radar scan range is adaptive to the current UAV flight status, including the UAV's velocity(v) and acceleration (a).

With a given scan update frequency (f), the maximum radar sensing range (Max(R)) is adaptively configured according to the UAV's velocity (v) and acceleration (a) using the following equation:

Max(R)=(v+a/f)/f. (3)

If a target is detected within the maximum sensing range Max(R), the flight direction, velocity and acceleration need to be adjusted to avoid a potential collision.

If there is no target detected in Max(R), the UAV will continue to travel according to its pre-defined trajectory.

What is claimed is:

1. A method for detecting an object, said method comprising:
providing a plurality of nonrotating transmitting and receiving antennas at a location;
transmitting an electromagnetic waveform from each of said plurality of nonrotating transmitting antennas for reflection from an object to be detected, each of said waveforms chosen so as to avoid interference with the other waveforms;
receiving reflected electromagnetic echo signals by the receiving antennas from the object to be detected and generating receiving signals corresponding to the echo signals; and
processing the receiving signals to determine relative location information about the object to be detected.

2. The method of claim 1 wherein the location is on an aircraft, wherein the relative location information is provided to a flight controller to control the flight of the aircraft with respect to the detected object.

3. The method of claim 1 wherein each transmit antenna is paired with a different one of the receiving antennas, each antenna pair being located on a different side of a polygon plane whereby the transmitting antennas together transmit the electronic waveforms over a 360 degree circumference, each transmitting antenna defining a separate azimuth region of the circumference, the number of azimuth regions corresponding to the number of edges on the polygon plane.

4. The method of claim 1 wherein the transmit antennas simultaneously transmit signals.

5. The method of claim 1 wherein the transmit antennas each transmit a specific waveform modulated at a different specified central frequency whereby the transmitted waveforms do not cause interference with each other.

6. The method of claim 1 wherein a transmit signal is first generated in a digital signal processor in digital form, then converted to an analog signal through a DAC (digital to analog converter), and the analog signal is then modulated in about a carrier frequency with an extended bandwidth through an RF modulator to create the transmitted electromagnetic waveform.

7. The method of claim 1 wherein the reflected echo signal from the object is conditioned and filtered, demodulated by an RF demodulator, converted to digital form by an analog to digital converter, and processed in a Digital Signal Processor to retrieve the relative location information.

8. The method of claim 1 wherein the electromagnetic waveforms are orthogonal waveforms.

9. The method of claim 2 wherein:
the receiving signals are processed by a signal processing algorithm based on a speed, heading direction, and acceleration of the aircraft
the 360-degree area around the aircraft is divided into 6 scan-regions, each scan region using a specific waveforms appropriate to its scan region, so an obstacle in one scan region will not generate any interference to other scan regions.

10. An apparatus for detecting an object, said apparatus comprising:
a plurality of nonrotating transmitting and receiving antennas at a location;
said plurality of nonrotating transmitting antennas each adapted to transmit an electromagnetic waveform for potential reflection from the object to be detected, each of said waveforms chosen so as to avoid interference with the other waveforms;
each of said plurality of nonrotating receiving antennas adapted to receiving a reflected electromagnetic echo signal from the object to be detected and transmitted from a different one of the plurality of transmitting antennas; and
a digital signal processor adapted to processing the reflected echo signals to determine relative location information about the object to be detected.

11. The apparatus of claim 10 wherein each transmit antenna is paired with one of the receiving antennas, each antenna pair being located on a different side of a polygon plane whereby the plurality of transmitting antennas together transmit the electronic waveforms over a 360 degree circumference, each transmitting antenna defining an azimuth region of the circumference, the number of azimuth regions corresponding to the number of edges on the polygon plane.

12. The apparatus of claim 10 wherein six antennas and RF front-end wall are installed in perpendicular to a hexagon main plane on each edge of plane; each antenna and RF front-end wall comprising a transmitting antenna, a receiving antenna and a radio frequency (RF) circuit to transmit high frequency signal through the transmitting antenna and to receive the reflected echo signal from the receiving antenna.

13. The apparatus of claim 10 wherein the transmitted waveforms are modulated at a specified central frequency to avoid interference with each other.

14. The apparatus of claim 10 wherein:
there are 6 pairs of transmit antennas and receive antennas, each pair being located on a different side of a hexagon structure;
each antenna pair is coded with a different start frequency and stop frequency, controlled by a main board processor;
the radar system apparatus runs on linear frequency modulated continuous-wave (LFMCW) principles; and
the apparatus is dimensioned and constructed to fit inside a UAV.

15. The apparatus of claim 10 wherein:
there are 8 pairs of transmit antennas and receive antennas, each pair being located on a different side of a octagon structure;

16. The apparatus of claim 10 wherein the antennas are strip antennas.

17. The apparatus of claim 11 wherein the antennas are formed on sidewalls of the polygon plane.
